(19) United States
(12) Patent Application Publication
(10) Pub. No.: US 2004/0129769 A1
(43) Pub. Date: Jul. 8, 2004

(54) Method for identifying and tracking test specimens

(76) Inventor: Aram Kovach, Lewis Center, OH (US)

Correspondence Address: Michael A. Forhan, Esq., Thompson Hine LLP, Suite 700, 10 W. Broad St., Columbus, OH, 43215-3435, US

(21) Appl. No.: 10/682,682

(22) Filed: Oct. 9, 2003

Related U.S. Application Data
(60) Provisional application No. 60/417,348, filed on Oct. 9, 2002.

(51) Int. Cl. G06F 17/00

(52) U.S. Cl. 235/375

(57) ABSTRACT

A method is disclosed for identifying and tracking test specimens using Radio-Frequency Identification (“RFID”) tags. The RFID tag typically contains an electronic microchip, which may be permanently attached to a substrate containing a small planar antenna. Each tag is encoded with a unique identifier and may be associated with a remote, computer-based record for the specimen. The tag may also electronically store information, such as test instructions, submitter data, specimen data, and testing status. The microchip is powered by an external Radio Frequency (“RF”) field provided by a corresponding interrogating scanner, which can read the data stored on the microchip and also provides a means for writing data into the microchip's memory. The RFID tag thus serves to not only uniquely identify the test specimen, but also provide current information regarding the status of the specimen.

### FIELD

This invention relates to a method for identifying and tracking items. Specifically, the invention relates to a method for identifying and tracking specimens collected for testing and analysis.

### BACKGROUND

Nearly every profession, industry, and discipline has some need for testing and analysis services. It is well known that the equipment necessary to perform many tests can be expensive. Further, the skills and resources required to interpret the test results and prepare reports are generally outside the realm of the party providing the specimen. In other cases, testing by a disinterested third party is desired to ensure accurate testing and impartial results. For these reasons and others, many specimens are sent to an outside test facility for testing.

There are many types of test facilities available to perform a wide variety of specialized tests. For example, biological materials such as blood may be collected by a physician's office or a medical clinic and sent to a medical laboratory for analysis as part of a patient's diagnosis and medical treatment. Other test facilities may perform environmental, life, and safety tests on products and materials. Still other test facilities may examine substances for purity and contamination, or examine products or materials to determine the root causes of failures. Another common requirement is regular testing of product samples for quality assurance purposes. Yet another common requirement is testing to ensure compliance with industry or government standards. The test specimens are collected or produced according to the needs of the particular profession, industry, or discipline, and sent to test facilities for testing in accordance with instructions provided by the submitter of the specimen.

The types of tests performed and the clientele may vary widely between test facilities serving disparate industries, professions, and disciplines. However, many test facilities share a common characteristic in that they receive large numbers of specimens, submitted from many different sources, for testing and analysis. From the perspective of the submitters of the test specimens, there are a number of concerns associated with outsourcing tests. First, there is the risk that some specimens may be inadvertently switched, mis-identified, lost, or contaminated. Thus, traceability and accountability are critical. Another potential problem is that the test facility may perform incorrect or incomplete testing due to a miscommunication between the submitter of the specimen and the test facility. Yet another problem is the delay in obtaining test results inherent in the specimen tracking and traceability procedures, as currently practiced. The test results may be further delayed if the order accompanying the specimen is lost and a replacement order is needed from the submitter. Still another problem is tracking the specimens within the test facility. The test facility may handle a large volume of specimens, many of which may closely resemble one another and are scheduled for multiple tests. It is all too easy to lose track of a specimen under these conditions.

The impact of these pitfalls can range from mere inconvenience to life-threatening, depending on the process problem that occurs with the specimen and the nature of the testing. There is a need for an improved method of identifying specimens collected for testing and analysis. In addition, there is a need for an improved method of tracking the physical location and testing status of specimens. There is a further need to reduce the time required to process and analyze specimens, especially biological ones.

### SUMMARY

The present invention provides a method for identifying and tracking test specimens and/or specimen containers using Radio-Frequency Identification (“RFID”) tags. An example RFID tag is the DURA-LABEL® tag manufactured by Single Chip Systems Corporation of San Diego, Calif. Alternative RFID tags and associated systems manufactured by others may likewise be satisfactorily utilized with the present invention.

An RFID tag typically contains an electronic microchip, which may be permanently attached to a substrate containing a small planar antenna. Each tag is typically encoded with at least a unique identifier which may correspond with a remote, computer-based record for the RFID-equipped specimen. The tag may also electronically store additional information, such as test instructions, submitter data, specimen data, and testing status. The tag contains an electronic microchip having a memory storage component, which is permanently attached to a substrate and contains a small antenna. The microchip is powered by the external Radio Frequency (“RF”) field provided by a corresponding interrogating scanner, which can read the data stored on the microchip and also provides a means for writing data into the microchip's memory.

A particular example of the disclosed invention is a method of identifying and tracking biological specimens. The RFID tag may be permanently attached to a biological specimen container. A specimen, such as blood or tissue, is collected by a medical facility such as a clinic, hospital, or physician's office and placed in the container. The RFID tag is energized by an external RF field and information may be written into the microchip's memory. Such information may include patient information, tests to be performed, the order of testing, and the status of the specimen in a multi-step process. The tagged specimen and electronic record can then be sent to an outside medical laboratory, which performs tests in accordance with the orders stored in the electronic record or on the RFID tag. The test results may then be electronically transmitted to the submitter of the specimen. This method reduces the chances for identification errors and the loss of specimens. The method also simplifies the tracking of biological specimens through the testing process and thus reduces the amount of time required to obtain test results.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a top plan view of an example RFID tag; and

FIG. 2 is a block diagram of the method for identifying and tracking test specimens according to an embodiment of the invention.

### DETAILED DESCRIPTION

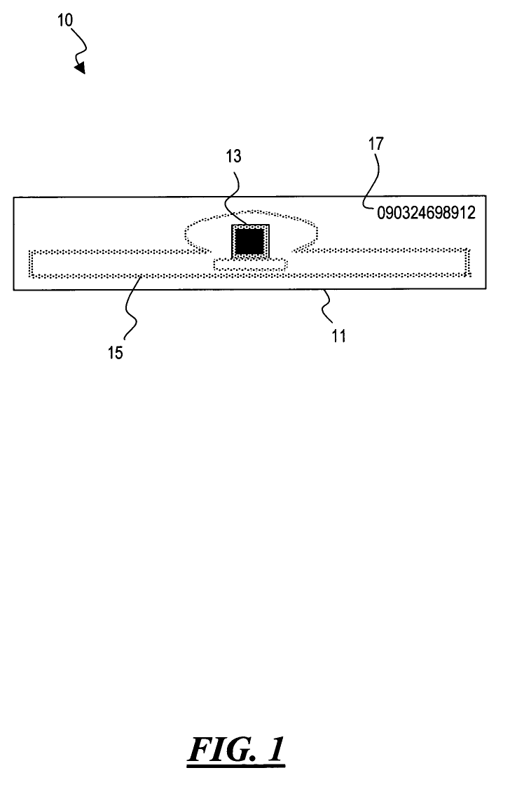

The general arrangement of one type of conventional RFID tag 10 usable with the present invention is illustrated in FIG. 1. RFID tag 10 is assembled on a flexible substrate 11, such as a plastic film. A microchip 13, permanently affixed to substrate 11, comprises a memory portion (not shown) adapted to electronically store data. Microchip 13 further comprises an RF-powered transmitter/receiver portion (not shown) to enable storage and retrieval of data from the memory portion by means of Radio Frequency (“RF”) energy. A planar antenna 15 is permanently affixed to substrate 11, and is electrically coupled to the transmitter/receiver portion of microchip 13. Each RFID tag 10 may have a unique identifier number 17 to distinguish it from other RFID tags 10.

In operation, microchip 13 of RFID tag 10 is powered by an external RF field provided by a corresponding interrogating scanner (not shown). The interrogating scanner also electrically communicates with RFID tag 10 to send data to the memory portion of microchip 13 and/or retrieve data stored on the memory portion.

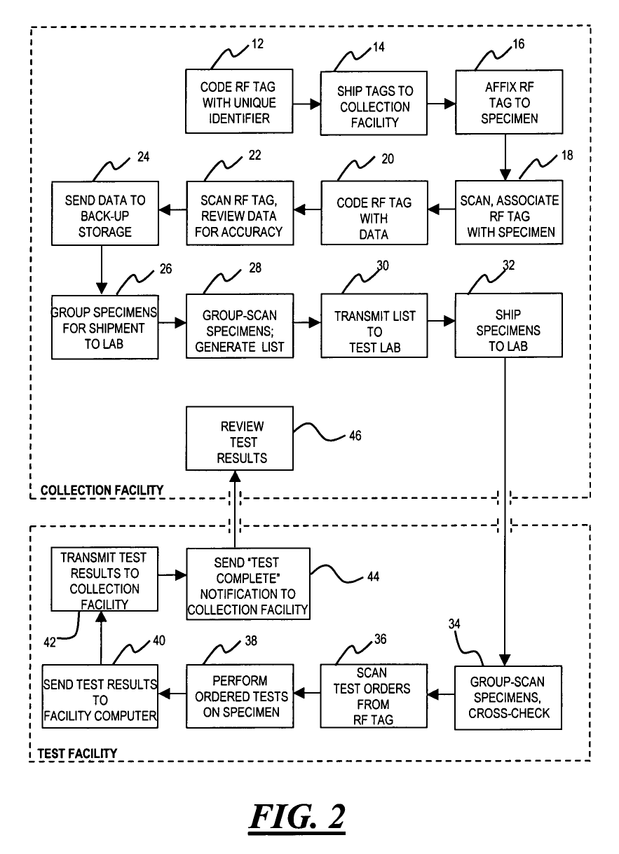

Referring now to FIG. 2 with continued reference to FIG. 1, a block diagram of the method for identifying and tracking test specimens is shown. An RFID tag 10 is first electronically coded with a unique identifier at step 12, then shipped to a collection facility at step 14. A “collection facility” may be loosely defined as any entity or facility that collects or produces test specimens for shipment to an outside test facility. Example collection facilities may include medical facilities, manufacturing facilities, and industrial or regulatory agencies.

An RFID tag 10 is affixed to a test specimen at step 16. Depending on the nature of the specimen and the testing to be performed, RFID tag 10 may be attached to a specimen container, or directly to the test specimen. For example, RFID tag 10 may be affixed to a collection container for blood samples, or directly attached to an appliance. The tagged specimen is then placed in proximity to a scanning device (not shown) at step 18. The scanning device provides an RF field that powers microchip 13 of RFID tag 10, allowing data to be written to and read from the microchip's memory. RFID tag 10 may be associated with the specimen by adding identifier number 17 for the tag to an electronic record kept within a computer system at the collection facility. The computer system may be a stand-alone terminal, or connected to a network such as, for example, an intranet or the Internet. Specimen-specific data may also be written to RFID tag 10 via the scanner's RF field at step 20. Such data may include submitter information, specimen information, the testing required, any particular test order requirements, and handling instructions. The testing information may be in the form of an industry or professional standard. For example, biological specimens may be tagged with a “Current Procedural Terminology” (“CPT”) code, which is a comprehensive listing of medical terms and codes published by the American Medical Association for the uniform designation of diagnostic and therapeutic procedures. The process of writing data to the microchip's memory portion may also be referred to herein as “coding” the RFID tag.

After data has been written to microchip 13 at step 20, RFID tag 10 may again be scanned at step 22 to verify that the data residing on the microchip is accurate and complete. If the information stored in microchip 13 is correct, the data may be sent to a backup storage location at step 24 for safekeeping. The specimen may then be placed with other tagged specimens for shipment to the outside test facility at step 26.

The specimens grouped together at step 26 may be scanned as a group in step 28 to generate a first list of all the specimens in a batch being sent to the test facility. The first list may include the RFID identifier number 17, and at least a portion of the data stored on RFID tags 10, as at step 20. The scanner is capable of individually interrogating each specimen in the group without a need to separately scan the specimens, thus reducing the amount of time needed to generate the list. This automated interrogation process also reduces handling and manual data entry, improving accuracy and reducing the risk of mis-placing a specimen. The first list is sent to the computer system within the collection facility, then communicated at step 30 to the test facility. The first list may be transmitted by any conventional means, such as courier, mail, facsimile, an electronic communications network (such as an intranet or the internet), and a secure internet connection commonly known in the art as a “Virtual Private Network” (“VPN”). The group of specimens is then shipped to the test facility by any conventional means at step 32.

Once the test specimens are received at the test facility, the group of specimens is once again scanned at step 34 and a second list is generated. The second list may be compared to the first list transmitted to the test facility at step 30, as a quality and accuracy check. The RFID tags 10 may then be scanned at step 36, either individually or as a group, to obtain any specimen-specific information that was previously written to the microchips 13 at step 20. Example information includes, but is not limited to, instructions or orders pertaining to the tests to be performed on the associated specimen, and special handling instructions for the specimen. The test facility may also create an electronic record for each specimen at step 34 or step 36, if desired. The specimens may then be routed to the proper locations within the test facility for testing at step 38. If testing requires that the test specimens be moved to multiple locations within the test facility, the information on RFID tag 10 may be updated and/or augmented by the testing facility at various testing stages with information pertaining to the test specimen, such as testing that has been completed, the current tests, testing yet to be performed, and the specimen's location. This information is preferably updated as the specimen progresses through each stage of the testing process. As the RFID tag 10 on each specimen is scanned to write updated information to microchip 13, the corresponding electronic record for the specimen, created at steps 34, 36, may also be updated, thus providing a convenient and accurate means for tracking the specimen's status and location. The record may be stored electronically in a computer system at the test facility. The computer system may be a stand-alone terminal, or be connected to an electronic communications network such as, for example, an intranet or the Internet.

Test results for the specimen are obtained by any conventional laboratory methods at step 38. At step 40 the results are added to the electronic record for the specimen, and optionally written to the RFID tag 10 associated with the specimen. The test results are transmitted from the test facility's computer system to the medical facility at step 42. The results may be transmitted by any conventional means, such as courier, mail, facsimile, an electronic communications network (such as an intranet or the internet), and a secure internet connection commonly known in the art as a “Virtual Private Network” (“VPN”). If a VPN is used, the data may be encrypted for privacy purposes and to guard against data tampering. A message is sent to the collection facility at step 44, notifying them that testing is complete and that the results are available. The notification may be accomplished by any conventional means, such as, for example, courier, an electronic communications network, electronic mail, facsimile, and telephone. Authorized personnel at the collection facility may review the test results at step 46. If the results are transmitted electronically, such as via an electronic communications network, the results may be viewed at a computer terminal, which may be part of an electronic communications network such as an intranet within the collection facility, or the internet, facilitating access to test result information using a palm or a hand-held device which is connected to the electronic communications network.

As can be seen, the disclosed method provides a more efficient and accurate means for identifying and tracking test specimens. This increased efficiency may result in cost savings, increased quality, and reduced turnaround time for testing and reporting results.

While this invention has been shown and described with respect to several detailed embodiments thereof, it will be understood by those skilled in the art that various changes in form and detail thereof may be made without departing from the scope of the claims of the invention. One skilled in the art will recognize that many of the separately-described functions of the various embodiments of the present invention may be combined, rearranged or eliminated to accomplish the desired result without affecting the scope of the invention. The embodiments disclosed herein are for illustrative purposes only and are not intended to be limiting with regard to the arrangement or combination of the components of the present invention.

What is claimed is:

1. A method for identifying and tracking a test specimen, comprising the steps of:
a) affixing at least one RFID tag to a select specimen at a collection facility;
b) associating the RFID tag with the specimen;
c) coding the RFID tag with specimen-specific data;
d) electrically scanning the RFID tag to generate a first list comprising at least a portion of the specimen-specific data;
e) communicating the first list from the collection facility to a test facility;
f) transporting the test specimen from the collection facility to the test facility;
g) electrically scanning the RFID tag at the test facility to obtain a second list comprising the specimen-specific data; and
h) comparing the first and second lists wherein the test facility can verify the identity of a selected test specimen received from a collection facility.

2. The method of claim 1, further comprising the steps of:
a) electrically scanning the RFID tag at the collection facility to obtain a back-up copy of the specimen-specific data; and
b) storing the back-up copy.

3. The method of claim 1 wherein the first list is communicated from the collection facility to the test facility via an electronic communications network.

4. The method of claim 1, further comprising the steps of:
a) coding the RFID tag at the collection facility with specimen-specific instructions relating to tests to be performed on the specimen; and
b) electrically scanning the RFID tag at the test facility to obtain a copy of the specimen-specific instructions.

5. The method of claim 4, further comprising the step of performing the specimen-specific tests on the test specimen.

6. The method of claim 5, wherein the RFID tag is coded by the test facility with data pertaining to the test specimen.

7. The method of claim 5, further comprising the step of communicating at least one test result from the test facility to the collection facility.

8. The method of claim 7 wherein the test result is communicated via an electronic communications network.

9. The method of claim 7, further comprising the step of notifying the collection facility that testing of a select specimen is complete.

10. The method of claim 9 wherein the notification is communicated via an electronic communications network.

11. A method for identifying and tracking test specimens within a batch, comprising the steps of:
a) affixing at least one RFID tag to each of a plurality of test specimens at a collection facility;
b) associating each RFID tag with the select specimen to which it is affixed;
c) coding each RFID tag with specimen-specific data;
d) electrically scanning the RFID tags of each of the specimens within a batch to generate a first list comprising at least a portion of the specimen-specific data of each specimen;
e) communicating the first list from the collection facility to a test facility;
f) transporting the batch of test specimens from the collection facility to the test facility;
g) electrically scanning the RFID tags of each of the specimens within a batch at the test facility to obtain a second list comprising specimen-specific data of each specimen; and
h) comparing the first and second lists wherein the test facility can verify the identity of each test specimen within a batch received from a collecting facility.

12. The method of claim 11 wherein the plurality of RFID tags within a batch are electrically scanned simultaneously as a group at the collection facility to generate the first list.

13. The method of claim 11 wherein the plurality of RFID tags within a batch are electrically scanned simultaneously as a group at the test facility to obtain the second list.

14. The method of claim 11, further comprising the steps of:
a) electrically scanning the RFID tags as a group at the collection facility to obtain back-up copies of the specimen data; and
b) storing the back-up copies.

15. The method of claim 11 wherein the first list is communicated from the collection facility to the test facility via an electronic communications network.

16. The method of claim 11, further comprising the steps of:
a) coding each RFID tag at the collection facility with data pertaining to instructions for specimen-specific testing to be performed on the specimen to which the tag is affixed; and
b) electrically scanning the RFID tags at the test facility to obtain copies of the instructions.

17. The method of claim 16, further comprising the step of performing the specimen-specific tests on each of the test specimens.

18. The method of claim 17, wherein the RFID tag of a select specimen is coded by the test facility with data pertaining to the test specimen.

19. The method of claim 17, further comprising the step of communicating at least one test result from the test facility to the collection facility.

20. The method of claim 19 wherein the test result is communicated via an electronic communications network.

21. The method of claim 19, further comprising the step of communicating a notification from the test facility to the collection facility that testing of the specimen is complete.

22. The method of claim 21 wherein the notification is communicated via an electronic communications network.
